(19) United States
(12) Patent Application Publication
(10) Pub. No.: US 2011/0008710 A1
(43) Pub. Date: Jan. 13, 2011

(54) MATERIAL FOR CATALYST LAYER FOR POLYMER ELECTROLYTE FUEL CELL

(75) Inventors: Atsushi WATAKABE, Tokyo (JP); Satoru Hommura, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Tokyo (JP)

(21) Appl. No.: 12/884,675

(22) Filed: Sep. 17, 2010

Related U.S. Application Data
(63) Continuation of application No. PCT/JP09/57212, filed on Apr. 8, 2009.

(30) Foreign Application Priority Data
Apr. 9, 2008 (JP) 2008-101477

(51) Int. Cl. H01M 8/10; H01M 4/88; B01J 31/06

(52) U.S. Cl. 429/492; 429/535; 502/159; 502/101

(57) ABSTRACT

To improve the utilization efficiency of a noble metal catalyst in a catalyst layer of an electrode for a polymer electrolyte fuel cell.

A precursor material obtained by polymerizing a perfluoromonomer having a fluorosulfonyl group in the presence of noble metal catalyst fine particles supported carbon particles, a material for a catalyst layer obtained by converting the fluorosulfonyl groups of the precursor material to sulfonic acid groups, and a membrane/electrode assembly for a polymer electrolyte fuel cell having a catalyst layer using the material for a catalyst layer.

### TECHNICAL FIELD

The present invention relates to a material for a catalyst layer for a polymer electrolyte fuel cell, a precursor material of the material for a catalyst layer, processes for producing the material for a catalyst layer and the precursor material, and a membrane/electrode assembly for a polymer electrolyte fuel cell using the material for a catalyst layer.

### BACKGROUND ART

A membrane/electrode assembly in a polymer electrolyte fuel cell has such a structure that electrode layers (one is an anode layer and the other is a cathode layer) are bonded to each side of a polymer electrolyte membrane. The electrode layer usually comprises a catalyst layer and a gas diffusion layer from the polymer electrolyte membrane side and may have another layer (such as a water repellent layer) between the catalyst layer and the gas diffusion layer or outside the gas diffusion layer in some cases. The catalyst layers are layers usually in contact with the polymer electrolyte membrane, and constitute an anode catalyst layer containing a catalyst which accelerates a reaction of forming hydrogen ions and electrons from hydrogen molecules and a cathode catalyst layer containing a catalyst which accelerates a reaction of forming water from hydrogen ions, oxygen molecules and electrons. As both catalysts, a noble metal catalyst such as platinum or a platinum alloy is used. The catalyst layer mainly comprises carbon particles having fine particles of the above catalyst supported and a polymer electrolyte.

For the polymer electrolyte in the polymer electrolyte membrane and in the catalyst layer, a sulfonic acid group-containing perfluoropolymer obtained by copolymerizing a perfluoromonomer having a fluorosulfonyl group (—SO₂F group) represented by the following formula and tetrafluoroethylene and then converting fluorosulfonyl groups in the obtained copolymer to sulfonic acid groups (—SO₃H groups) has been commonly used. In the following formula, Y is a fluorine atom or a trifluoromethyl group, n is an integer of from 1 to 12, m is an integer of from 0 to 3, and p is 0 or 1, provided that m+p>0.

CF₂═CF—(OCF₂CFY)ₘ—Oₚ—(CF₂)ₙ—SO₂F

The catalyst layer is usually formed by mixing a powder of catalyst supported carbon particles and a polymer electrolyte, and forming the resulting mixture to a sheet, which is laminated on an electrolyte membrane, or by applying a slurry of the mixture on an electrolyte membrane. As the catalyst supported carbon particles, carbon black having fine particles of a platinum catalyst supported may be mentioned as a typical example. In the catalyst layer, in addition to the above two components, a reinforcing material such as fibrillated polytetrafluoroethylene, a binder such as a thermoplastic fluororesin, a water repellent such as a fluorinated water repellent, etc. may optionally be blended.

It is considered that in the catalyst layer, the catalyst fine particles supported on the carbon particles and the polymer electrolyte should be sufficiently contacted with each other. It is considered that typical catalyst fine particles supported carbon black comprises agglomerated particles (secondary particles) having a diameter at a level of from 0.1 to 1 μm having carbon particles (primary particles) having a diameter at a level of from 10 to 50 nm having catalyst fine particles having a diameter at a level of from 1 to 5 nm supported, agglomerated. The agglomerated particles (secondary particles) are a porous material, and the primary particles are also considered to be a porous material. It is considered that in the mixture of the catalyst fine particles supported carbon black and the polymer electrolyte, the internal space of the agglomerated particles is not sufficiently filled with the polymer electrolyte, and there are a large amount of space not filled with the polymer electrolyte (that is, a large amount of the primary particle surface not in contact with the polymer electrolyte is present). Accordingly, it is considered that a large amount of the catalyst fine particles present on the surface of the primary particles are not in contact with the polymer electrolyte. Further, it is considered that even if the surface of the primary particles is covered with the polymer electrolyte, the interior of the pores of the primary particles is not sufficiently filled with the polymer electrolyte, and the catalyst fine particles present in the pores are not in contact with the polymer electrolyte (Non-Patent Document 1).

It is considered that to express the catalytic activity by the catalyst fine particles, it is necessary that the catalyst fine particles are in contact with the polymer electrolyte which constitute a migration channel for hydrogen ions. That is, it is considered that in the anode catalyst layer, hydrogen ions formed on the surface of the catalyst fine particles move through a polymer electrolyte in contact with the surface of the catalyst fine particles, and in the cathode catalyst layer, hydrogen ions move through the polymer electrolyte and reach the surface of the catalyst fine particles and react with oxygen molecules there to form water. Accordingly, the catalyst fine particles not in contact with the polymer electrolyte do not function as a catalyst, and as the amount of the catalyst fine particles not in contact with the polymer electrolyte increases, the utilization efficiency of the catalyst will be decreased. Since the catalyst used for the catalyst layer is a noble metal catalyst of e.g. platinum or a platinum alloy and is an expensive material and is a rare resource, improvement in the utilization efficiency of the catalyst has been desired.

As a means of increasing the contact area of the noble metal catalyst fine particles supported carbon particles and the polymer electrolyte, a method of making a colloidal polymer electrolyte be adsorbed in the noble metal catalyst fine particles supported carbon particles has been known (Non-Patent Document 1, Patent Document 1). It is said that by this adsorption method, even the internal space of the secondary particles of the carbon particles can be filled with the polymer electrolyte. Further, it is expected that by making the polymer electrolyte be finer and be adsorbed in the noble metal catalyst fine particles supported carbon particles, the polymer electrolyte can be introduced even inside the pores of the primary particles of the noble metal catalyst fine particles supported carbon particles, and that the polymer electrolyte can be in contact with the catalyst fine particles even inside the pores (Non-Patent Document 1). However, it is not easy to produce sufficiently fine polymer electrolyte fine particles, and it is also not easy to sufficiently fill the internal space of the secondary particles and even the interior of the pores of the primary particles of the noble metal catalyst fine particles supported carbon particles with the polymer electrolyte e.g. by adsorption.

On the other hand, it has been known to produce a polymer electrolyte material containing noble metal catalyst fine particles supported carbon particles by mixing a reaction curable sulfonic acid group-containing compound with a powder of the noble metal catalyst fine particles supported carbon particles, and reacting the mixture for curing (Patent Document 2). It is said that by use of a liquid low viscosity low molecular compound as a reaction curable sulfonic acid group-containing compound, the reaction curable sulfonic acid group-containing compound sufficiently infiltrates into the space in the secondary particles and the interior of the pores of the primary particles of the noble metal catalyst fine particles supported carbon particles. Further, it is said that by reacting the reaction curable sulfonic acid group-containing compound for curing (increase in the molecular weight) to obtain a polymer electrolyte, a material having the internal space of the secondary particles and the interior of the pores of the primary particles of the noble metal catalyst fine particles supported carbon particles sufficiently filled with the polymer electrolyte can be obtained. Specifically, by using a sulfonic acid group-containing hydrolyzable silane compound and another hydrolyzable silane compound, a polymer electrolyte comprising a sulfonic acid group-containing organopolysiloxane is formed. However, evaluation of the sulfonic acid group-containing organopolysiloxane as a polymer electrolyte for a polymer electrolyte fuel cell is not sufficient as compared with the above-mentioned commonly used sulfonic acid group-containing perfluoropolymer. Accordingly, it is forecast that its electrical properties as a polymer electrolyte, chemical or mechanical properties such as durability, properties in preparation of an electrode layer such as processability, etc. are not sufficient as compared with the above sulfonic acid group-containing perfluoropolymer.

### PRIOR ART REFERENCE

Patent Document 1: JP-A-9-92293

Patent Document 2: JP-A-2005-32668

Non-Patent Document 1: “Denshi to ion no kinoukagaku series (Functional Chemistry Series of Electron and Ion) vol. 4, Kotaikoubunshigata nenryodenchi no subete (Encyclopedia of Polymer Electrolyte Fuel cell), Oct. 1, 2003 (NTS Inc.), pages 96 to 136

### DISCLOSURE OF THE INVENTION

### Object to be Accomplished by the Invention

It is an object of the present invention to improve the utilization efficiency of a noble metal catalyst in a polymer electrolyte fuel cell using a sulfonic acid group-containing perfluoropolymer such as the above-described sulfonic acid group-containing perfluoropolymer which has been highly evaluated as a polymer electrolyte for a polymer electrolyte fuel cell. By improving the utilization efficiency (mass activity of the catalyst) of the noble metal catalyst, the output current can be increased as compared with conventional one, and the output current comparable to that of conventional one can be obtained with a smaller amount of the catalyst.

The present invention provides a material for a catalyst layer with a high utilization efficiency of a noble metal catalyst, and its production process. Further, it provides a precursor material for production of the material for a catalyst layer and its production process, and a membrane/electrode assembly for a polymer electrolyte fuel cell having a catalyst layer using the material for a catalyst layer.

### Means to Accomplish the Object

The present invention relates to a material for a catalyst layer for a polymer electrolyte fuel cell, a precursor material of the material for a catalyst layer, processes for producing the material for a catalyst layer and the precursor material, and a membrane/electrode assembly for a polymer electrolyte fuel cell using the material for a catalyst layer, and provides the following.

<1> A precursor material of a material for a catalyst layer for a polymer electrolyte fuel cell, comprising carbon particles having noble metal catalyst fine particles supported and a perfluoropolymer having fluorosulfonyl groups, wherein the perfluoropolymer having fluorosulfonyl groups is obtained by polymerizing a perfluoromonomer having a fluorosulfonyl group in the presence of the noble metal catalyst fine particles supported carbon particles.
<2> The precursor material according to the above <1>, which contains from 5 to 300 parts by mass of the perfluoropolymer having fluorosulfonyl groups per 100 parts by mass of carbon of the noble metal catalyst fine particles supported carbon particles.
<3> The precursor material according to the above <1> or <2>, wherein the perfluoropolymer having fluorosulfonyl groups is a crosslinked perfluoropolymer.
<4> A material for a catalyst layer for a polymer electrolyte fuel cell, comprising carbon particles having noble metal catalyst fine particles supported and a perfluoropolymer having sulfonic acid groups, wherein the perfluoropolymer having sulfonic acid groups is obtained by polymerizing a perfluoromonomer having a fluorosulfonyl group in the presence of the noble metal catalyst fine particles supported carbon particles, and then converting the fluorosulfonyl groups of the polymer to sulfonic acid groups.
   <5> The material for a catalyst layer according to the above <4>, which contains from 5 to 300 parts by mass of the perfluoropolymer having sulfonic acid groups per 100 parts by mass of carbon of the noble metal catalyst fine particles supported carbon particles.
   <6> The material for a catalyst layer according to the above <4> or <5>, wherein the perfluoropolymer having sulfonic acid groups is a crosslinked perfluoropolymer.
   <7> A process for producing a precursor material of a material for a catalyst layer for a polymer electrolyte fuel cell, comprising carbon particles having noble metal catalyst fine particles supported and a perfluoropolymer having fluorosulfonyl groups, which comprises polymerizing a perfluoromonomer having a fluorosulfonyl group in the presence of the noble metal catalyst fine particles supported carbon particles to form the perfluoropolymer having fluorosulfonyl groups.
   <8> The process for producing a precursor material according to the above <7>, wherein a perfluoromonomer having no fluorosulfonyl group is copolymerized together with the perfluoromonomer having a fluorosulfonyl group.
   <9> The process for producing a precursor material according to the above <8>, wherein the perfluoromonomer having no fluorosulfonyl group is a perfluoromonomer having at least two addition polymerizable groups.
   <10> The process for producing a precursor material according to any one of the above <7> to <9>, wherein the perfluoromonomer having a fluorosulfonyl group is a perfluoromonomer having a 2-methylene-1,3-dioxolane structure.
   <11> The process for producing a precursor material according to any one of the above <7> to <10>, wherein polymerization is carried out in an aqueous medium.
   <12> The process for producing a precursor material according to any one of the above <7> to <11>, wherein the precursor material contains from 5 to 300 parts by mass of the perfluoropolymer having fluorosulfonyl groups per 100 parts by mass of carbon of the noble metal catalyst fine particles supported carbon particles.
   <13> A process for producing a material for a catalyst layer for a polymer electrolyte fuel cell, comprising carbon particles having noble metal catalyst fine particles supported and a perfluoropolymer having sulfonic acid groups, which comprises producing the precursor material by the production process as defined in any one of the above <7> to <12>, and then converting fluorosulfonyl groups of the polymer in the precursor material to sulfonic acid groups to obtain the perfluoropolymer having sulfonic acid groups.
   <14> The process for producing a material for a catalyst layer according to the above <13>, wherein the perfluoropolymer having sulfonic acid groups has an ion exchange capacity of from 0.5 to 3.5 meq/g dry polymer.
   <15> A membrane/electrode assembly for a polymer electrolyte fuel cell comprising an anode layer containing a catalyst layer, a cathode layer containing a catalyst layer, and a polymer electrolyte membrane disposed between the anode layer and the cathode layer, wherein the catalyst layer of at least one of the anode layer and the cathode layer contains the material for a catalyst layer as defined in any one of the above <4> to <6>.
   <16> A process for producing a membrane/electrode assembly for a polymer electrolyte fuel cell comprising an anode layer containing a catalyst layer, a cathode layer containing a catalyst layer, and a polymer electrolyte membrane disposed between the anode layer and the cathode layer, which comprises producing a material for a catalyst layer by the production process as defined in the above <13> or <14>, and then forming a catalyst layer using the material for a catalyst layer on at least one side of the polymer electrolyte membrane (provided that when the catalyst layer using the material for a catalyst layer is formed on only one side, the other catalyst layer is formed by another material).

### EFFECTS OF THE INVENTION

By the present invention, the utilization efficiency (mass activity of the catalyst) of a noble metal catalyst in a catalyst layer in a polymer electrolyte fuel cell can be improved. By the improvement in the utilization efficiency of the noble metal catalyst, the output current can be increased as compared with conventional one, and the output current comparable to that of conventional one can be obtained by use of a noble metal catalyst in an amount smaller than conventional one.

### BEST MODE FOR CARRYING OUT THE INVENTION

In the present invention, the precursor material of a material for a catalyst layer for a polymer electrolyte fuel cell is a material comprising carbon particles having noble metal catalyst fine particles supported and a perfluoropolymer having fluorosulfonyl groups, and is a material to be a material for a catalyst layer by converting the fluorosulfonyl groups in the perfluoropolymer to sulfonic acid groups. Further, the perfluoropolymer having fluorosulfonyl groups will sometimes be referred to as “a precursor”, and the fluorosulfonyl groups will sometimes be referred to as “precursor groups”.

In the present invention, the material for a catalyst layer is a material for preparation of a catalyst layer for a polymer electrolyte fuel cell, and contains carbon particles having noble metal catalyst fine particles supported and a perfluoropolymer having sulfonic acid groups. The catalyst layer of a polymer electrolyte fuel cell is prepared only from this material for a catalyst layer or by combining this material for a catalyst layer with other optional raw material forming the catalyst layer.

In the present invention, unless otherwise specified, a monomer means a compound having an addition polymerizable unsaturated double bond (sometimes referred to as an addition polymerizable group in the present invention). Among monomers, a compound having one addition polymerizable unsaturated double bond will sometimes be referred to as a monoene, and a compound having two addition polymerization unsaturated double bonds will sometimes be referred to as a diene. Further, compounds having at least two addition polymerizable unsaturated double bonds will generically be referred to as a polyene.

Now, the present invention will be described starting from the raw materials.

### <Carbon Particles Having Noble Metal Catalyst Fine Particles Supported>

As the noble metal catalyst, a catalyst comprising a metal element selected from the group consisting of elements of the platinum group and rhenium, or a catalyst comprising an alloy or an intermetallic compound containing at least one metal element selected from the group consisting of elements of the platinum group and rhenium is preferred. As the element of the platinum group, platinum, palladium, ruthenium, rhodium or the like is particularly preferred. The above alloy may, for example, be platinum-palladium, platinum-ruthenium, platinum-rhodium or palladium-rhodium. The intermetallic compound may, for example, be TiPt₃ or TiPt₂. The noble metal catalyst in the anode catalyst layer is preferably platinum or a platinum-ruthenium alloy, and the noble metal catalyst in the cathode catalyst layer is preferably platinum or a platinum-cobalt alloy.

As the carbon material as a material of the carbon particles which support the catalyst, various carbon materials such as carbon black of which the pores are developed, activated carbon, carbon nanotubes or carbon nanohorns may be preferably used. For a polymer electrolyte fuel cell, usually carbon black is used in many cases, and the carbon black may, for example, be channel black, furnace black, thermal black or acetylene black. Further, as the activated carbon, various activated carbons obtained by subjecting various materials containing carbon atoms to carbonization and activation treatment may be used. The specific surface area of the carbon particles is preferably at least 200 m²/g, particularly preferably from 400 to 1,000 m²/g. When carbon particles having a small specific surface area are used, the utilization efficiency of the catalyst tends to be decreased. The specific surface area means the specific surface area (JIS K6217-2:2001) measured by nitrogen adsorption method (nitrogen BET method). The size of the carbon particles is not particularly limited, but particles having a maximum length of at most 100 μm are suitable. As described above, in the case of the carbon black, carbon black comprising agglomerated particles (secondary particles) having a diameter at a level of from 0.1 to 1 μm having primary particles having a diameter at a level of from 10 to 50 nm agglomerated can be used.

The amount of the noble metal catalyst supported on the carbon particles is preferably from 10 to 70 mass %, particularly preferably from 40 to 60 mass % to the noble metal catalyst supported carbon particles. If the amount of the noble metal catalyst supported is too small, the amount of catalyst required for the reaction may be insufficient, and if the amount of the catalyst supported is too large, agglomeration of the catalyst fine particles is likely to occur on the carbon particles, whereby the performance may rather be decreased.

The average particle size (as obtained by measurement by X-ray diffraction) of the noble metal catalyst fine particles is at the same level as the average particle size of the catalyst fine particles in the noble metal catalyst fine particles supported on carbon particles which have been used as a catalyst for a fuel cell. The average particle size is preferably from 1 to 10 nm, particularly preferably from 1 to 5 nm.

The noble metal catalyst fine particles supported carbon particles are obtained usually by making the noble metal compound be supported on the carbon particles and reducing it. By the noble metal compound being reduced on the surface of the carbon particles, fine particles of the noble metal are precipitated on the surface of the carbon particles. For example, the solution of a solvent-soluble noble metal compound and carbon particles are brought into contact with each other to attach the noble metal compound to the carbon particles, the solvent is removed, and then the noble metal compound is converted to a noble metal thereby to form noble metal fine particles on the carbon particles. The reaction of converting the noble metal compound to a noble metal is usually a reduction reaction, and for example, by heating the noble metal compound in hydrogen-containing nitrogen, the noble metal fine particles can be formed. It is possible to similarly form a noble metal catalyst such as an alloy or a solid solution of a noble metal with another metal by using another metal compound together with the noble metal compound. As the metal compound, a metallic acid, a metallic acid salt, a metal complex or the like may be used. For example, in the case of a platinum compound, chloroplatinic acid, chloroplatinate, dinitrodiammine platinum (Pt(NH₃)₂(NO₂)₂) or the like may be used.

The noble metal catalyst fine particles supported carbon particles used in the present invention are not limited to one prepared by the above method. Further, commercially available noble metal catalyst fine particles supported carbon particles for a fuel cell may be used.

### <Perfluoromonomer Having Fluorosulfonyl Group>

The perfluoromonomer having a fluorosulfonyl group means a perfluoro compound:a compound having fluorine atoms instead of hydrogen atoms bonded to carbon atoms, and having substantially no hydrogen atom bonded to carbon atoms, and some of fluorine atoms bonded to carbon atoms may be substituted by a chlorine atom) having a fluorosulfonyl group and an addition polymerizable group. Hereinafter this perfluoromonomer having a fluorosulfonyl group will be referred to as a monomer (a). The monomer (a) is preferably a perfluoro compound having at least one fluorosulfonyl group and one addition polymerizable group. The monomer (a) as the perfluoro compound is a monoene since it has one addition polymerizable group, and hereinafter this compound will be referred to as “a fluorosulfonyl group-containing perfluoromonoene”. The number of fluorosulfonyl group in the fluorosulfonyl group-containing perfluoromonoene is preferably 1 or 2.

As the monomer (a) for preparation of the perfluoropolymer having fluorosulfonyl groups, two or more different monomers (a) may be used. However, usually the perfluoropolymer is prepared by using one monomer (a). The perfluoropolymer having fluorosulfonyl groups is preferably a copolymer obtained by copolymerizing the monomer (a) and another perfluoromonomer. A polymer obtained by polymerizing the monomer (a) alone tends to be insufficient in mechanical properties such as strength and durability. Accordingly, in order to compensate such drawbacks, it is preferred to copolymerize a monomer having no fluorosulfonyl group copolymerizable with the monomer (a) with the monomer (a).

As the fluorosulfonyl group-containing perfluoromonoene, a known compound may be used. For example, a fluorosulfonyl group-containing perfluoromonoene represented by the following formula (1) used for preparation of the above-described common sulfonic acid group-containing perfluoropolymer may be used. In addition, perfluoromonoenes having one or two fluorosulfonyl groups represented by the following formulae (2) to (6) may be used.

In order to obtain a resin having a high ion exchange capacity and a high proton conductivity, it is preferred to use monoenes of the following formulae (4) to (6) having high polymerizability. By use of such monoenes, it is easy to increase the ratio of the amount of the fluorosulfonyl group-containing polymer to the amount of carbon in the noble metal catalyst fine particles supported carbon particles. Use of the monoene of the following formula (4) is particularly suitable in view of easiness of preparation.

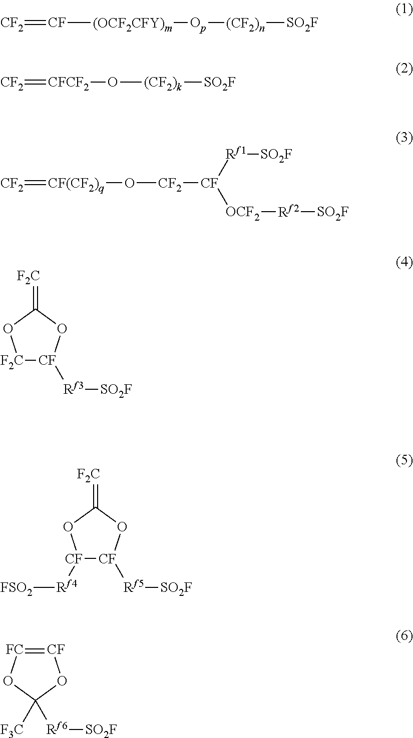

In the above formulae, Y is a fluorine atom or a trifluoromethyl group, n is an integer of from 1 to 12, m is an integer of from 0 to 3, and p is 0 or 1 (provided that m+p>o). k is an integer of from 2 to 6. Each of R^{f1} and R^{f2} which are independent of each other, is a single bond or a C₁₋₆ linear perfluoroalkylene group which may have an etheric oxygen atom. q is 0 or 1. R^{f3} is a C₁₋₆ perfluoroalkylene group which may have an etheric oxygen atom. Each of R^{f4} and R^{f5} which are independent of each other, is a C₁₋₈ perfluoroalkylene group which may have an etheric oxygen atom. R^{f6} is a C₁₋₆ perfluoroalkylene group which may have an etheric oxygen atom.

### <Perfluoromonomer Having No Fluorosulfonyl Group>

The perfluoropolymer having fluorosulfonyl groups is preferably a copolymer of the above monomer (a) and the above monomer having no fluorosulfonyl group copolymerizable with the monomer (a). The monomer having no fluorosulfonyl group copolymerizable with the monomer (a) is preferably a perfluoromonomer having no fluorosulfonyl group (hereinafter referred to as a monomer (b)). The monomer (b) is preferably a perfluoro compound having at least one addition polymerizable group. The monomer (b) is a monoene or a polyene, and is preferably a monoene or a diene. As the monomer (b) for preparation of the perfluoropolymer having fluorosulfonyl groups, at least two monomers (b) may be used.

The perfluoromonoene as the monomer (b), a perfluoromonoene which has been used for preparation of various perfluoropolymers, or known as a monomer for preparation of various perfluoropolymers, may be used. The perfluoromoene may, for example, be a perfluoroolefin such as tetrafluoroethylene (hereinafter sometimes referred to as TFE), a perfluoro(alkyl alkenyl ether) such as a perfluoro(alkyl vinyl ether), or a perfluorocyclic ether monoene such as perfluoro(2,2-dimethyl-1,3-dioxole) or perfluoro(2-methylene-1,3-dioxolane).

As the perfluorodiene as the monomer (b), a perfluorodiene which has been used for preparation of various perfluoropolymers or known as a monomer for preparation of various perfluoropolymers, may be used. It may, for example, be a perfluoroalkadiene, a perfluoro(dialkenyl ether), a perfluoro(dialkenyloxyalkane) or a perfluoroalkane having two residues of a perfluorocyclic ether monoene. As the perfluoropolyene as the monomer (b), other than the perfluorodiene, a perfluoro compound having 3 to 5 addition polymerization groups is preferred, and a perfluoroalkane having 3 to 5 perfluoroalkenyloxy groups is particularly preferred.

Some of the perfluoropolyenes are cyclopolymerizable monomers, and for example, a perfluorodiene such as perfluoro(allyl vinyl ether) or perfluoro(3-butenyl vinyl ether) cyclopolymerize to be a linear polymer having rings in its main chain. Accordingly, when such a cyclopolymerizable perfluorodiene is copolymerized as the monomer (b) with the monomer (a), the perfluoropolymer having fluorosulfonyl groups to be obtained is a linear polymer. Usually, the cyclopolymerizable monomer is a compound having such a molecular structure that the minimum distance between two addition polymerizable groups is a distance corresponding to 2 to 4 atoms represented by the number of atoms such as carbon atoms or oxygen atoms. It has been known that from perfluoro(3,6-dioxa-1,7-octadiene) [CF₂═CFOCF₂CF₂OCF═CF₂], a linear polymer is formed by cyclopolymerization when its concentration is low, and a crosslinked polymer is formed when its concentration is high. In the present invention, such a monomer may also be used as the monomer (b).

The polyenes other than the cyclic polymerizable monomer are crosslinkable monomers. When the monomer (b) as the crosslinkable monomer is copolymerized with the monomer (a), a perfluoropolymer having fluorosulfonyl groups to be obtained is a crosslinked polymer having a network or space lattice structure. The crosslinked polymer is a polymer having no thermoplasiticity, and has low or no solubility in a solvent. Accordingly, as compared with the linear polymer, the crosslinked polymer is difficult to mold, and if it is highly crosslinked, it tends to be a fragile polymer. On the other hand, the crosslinked polymer tends to be a highly durable polymer from such reasons that it has a low solubility in a solvent, it has low water swelling properties, and decrease in the molecular weight by breakage of the polymer chain is less likely to occur. As described hereinafter, the perfluoropolymer having fluorosulfonyl groups in the present invention and thus the perfluoropolymer having sulfonic acid groups are preferably a crosslinked polymer. Accordingly, at least some of the monomers (b) used in the present invention are preferably crosslinkable monomers. Hereinafter such a crosslinkable monomer will be referred to as a crosslinkable monomer (b). As described above, the crosslinkable monomer (b) is a polyene other than the cyclopolymerizable monomer, and is preferably a perfluorodiene as described above. As the perfluorodiene as the crosslinkable monomer (b), for example, compounds represented by the following formulae (7) to (9) are preferred.

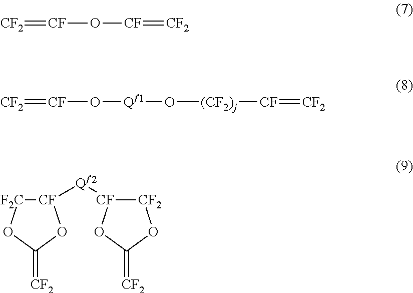

In the above formulae, Q^{f1} is a C₃₋₂₀ perfluoroalkylene group which may have an oxygen atom between carbon atoms, and j is 0 or 1. Q^{f2} is a single bond, an oxygen atom, a C₁₋₅ perfluoroalkylene group, or a C₁₋₅ perfluoroalkylene group having an etheric oxygen atom inserted between the carbon-carbon atoms.

The above Q^{f1} is preferably the following group.

—(CF₂)ₐ—

—(CF₂CFYO)_{b}—(CF₂)_{c}—(OCFYCF₂)_{d}—

wherein “a” is an integer of from 3 to 12, Y is a fluorine atom or a trifluoromethyl group, b is an integer of at least 1, c is an integer of at least 2, and d is an integer of at least 0, provided that b+c+d satisfies the total number of carbon atoms of at most 24.

### <Perfluoropolymer Having Fluorosulfonyl Groups>

The perfluoropolymer having fluorosulfonyl groups produced in the present invention is a perfluoropolymer having monomer units (hereinafter referred to as monomer units (a)) formed by polymerization of the monomer (a). Preferably, it is a perfluoropolymer having monomer units (hereinafter referred to as monomer units (b)) formed by polymerization of the monomer (b) in addition to the monomer units (a). Two or more kinds of the respective monomer units may be contained.

The perfluoropolymer having fluorosulfonyl groups is a precursor of a perfluoropolymer having sulfonic acid groups, and by converting the fluorosulfonyl groups in the polymer to sulfonic acid groups, a sulfonic acid group-containing perfluoropolymer is obtained. Accordingly, the density of sulfonic acid groups (represented by the ion exchange capacity in the present invention) in the sulfonic acid group-containing perfluoropolymer depends on the density of the fluorosulfonyl groups in the perfluoropolymer having fluorosulfonyl groups. The density of the fluorosulfonyl groups in the perfluoropolymer is considered to substantially depend on the molar ratio of the monomer units (a) to all the monomer units, the number (usually one or two) of fluorosulfonyl groups which the monomer unit (a) has, and the molecular weights of the respective monomer units. Accordingly, in order to obtain a sulfonic acid group-containing perfluoropolymer having a high density of sulfonic acid groups, a fluorosulfonyl group-containing perfluoropolymer having a high density of fluorosulfonyl groups is required.

Heretofore, in the sulfonic acid group-containing perfluoropolymer, the ratio of units having sulfonic acid groups (units derived from the monomer units (a), and hereinafter referred to as units (s)) in the polymer (i.e. the molar ratio of the units (s) to all the units in the polymer) has been restricted. A polymer having a high ratio of the units (s) has low mechanical properties such as strength and durability. Accordingly, in order to compensate such physical properties, a relatively large amount of the monomer units (b) such as tetrafluoroethylene units have been contained. On the other hand, sulfonic acid groups are groups which cause migration of hydrogen ions, and it is considered that a polymer having a higher density of sulfonic acid groups has more excellent effect as a polymer electrolyte. As a sulfonic acid group-containing perfluoropolymer having a high ratio of the units (s) and having high mechanical and chemical properties, a crosslinked polymer is considered. However, a crosslinked polymer has low moldability, and for example, it has been difficult to uniformly mix a powder comprising catalyst supported carbon particles with the crosslinked polymer to bring them into close contact with each other and to make the mixture into a layer in the form of a thin sheet.

As described hereinafter, in the present invention, a material for a catalyst layer in which a powder comprising the catalyst supported carbon particles and the sulfonic acid group-containing perfluoropolymer are in close contact with each other can be obtained without a step of mixing them. Accordingly, the sulfonic acid group-containing perfluoropolymer may be a crosslinked polymer, and is rather preferably a crosslinked polymer since a polymer having a high density of sulfonic acid groups and a polymer having high mechanical and chemical durability can be obtained. In the present invention, since mixing to bring the catalyst supported carbon particles and the polymer into uniform and close contact with each other is not required, low processability of a non-thermoplastic crosslinked polymer having no solubility in a solvent is hardly problematic. Further, even when a solvent is used in hydrolysis of the fluorosulfonyl group-containing perfluoropolymer or in formation of a catalyst layer from the material for a catalyst layer, the polymer is hardly soluble in a solvent, and the close contact of the carbon particles and the polymer at the time of forming the polymer is hardly inhibited.

Further, also in a case where the sulfonic acid group-containing perfluoropolymer is a linear polymer, since a material in which the catalyst supported carbon particles and the linear polymer are in close contact with each other as compared with conventional one is obtained, a material for a catalyst layer having excellent physical properties (including electrochemical properties) as compared with conventional one can be obtained even when the physical properties such as the density of sulfonic acid groups and the polymer structure of the sulfonic acid group-containing perfluoropolymer itself are at the same level as those of a conventional polymer. Further, the sulfonic acid group-containing perfluoropolymer to be used for a catalyst layer is not required to have very high mechanical properties as compared with a sulfonic acid group-containing perfluoropolymer for a polymer electrolyte membrane, and from such a viewpoint also, the sulfonic acid group density can be set high as compared with the sulfonic acid group-containing perfluoropolymer for a polymer electrolyte membrane.

In the fluorosulfonyl group-containing perfluoropolymer in the present invention, the ratio of the monomer units (a) is preferably from 5 to 99.9 mol %, particularly preferably from 10 to 99.5 mol % to all the monomer units. Further, in a case where the fluorosulfonyl group-containing perfluoropolymer is a linear polymer (that is, the monomer units (b) are monomer units of a monoene or a cyclopolymerizable polyene), the ratio of the monomer units is preferably from 5 to 70 mol %, more preferably from 10 to 60 mol %, particularly preferably from 15 to 50 mol % to all the monomer units. In a case where the fluorosulfonyl group-containing perfluoropolymer is a crosslinked polymer (that is, in a case where the monomer units (b) contain monomer units of the crosslinkable monomer (b), the ratio of the monomer units (a) is preferably from 20 to 99.9 mol %, more preferably from 50 to 99.5 mol %, particular preferably from 70 to 99 mol % to all the monomer units. Like the linear polymer, a crosslinked polymer having a low ratio of the monomer units (a) may be used, but in order to make use of properties of the crosslinked polymer, a polymer having a high ratio of the monomer units (a) is preferred as described above.

In a case where the fluorosulfonyl group-containing perfluoropolymer is a crosslinked polymer, as the monomer units (b), monomer units of a non-crosslinkable monomer (b) may be contained in addition to the monomer units of the crosslinkable monomer (b). Including such a case, the ratio of the monomer units of the crosslinkable monomer (b) is preferably from 0.1 to 80 mol %, more preferably from 0.5 to 50 mol %, particularly preferably from 1 to 30 mol % to all the monomer units in the fluorosulfonyl group-containing perfluoropolymer as a crosslinked polymer.

Further, the molecular weight of the monomer units (a) and the number of the fluorosulfonyl groups in the monomer units (a) in the fluorosulfonyl group-containing perfluoropolymer relate to the after-mentioned ion exchange capacity of the sulfonic acid group-containing perfluoropolymer. Accordingly, by adjusting the molar fraction of the monomer units (a) in accordance with the aimed ion exchange capacity of the sulfonic acid group-containing perfluoropolymer, a perfluoropolymer having a required fluorosulfonyl group density can be obtained.

Further, the weight average molecular weight of the linear fluorosulfonyl group-containing perfluoropolymer is preferably from 1×10⁴ to 1×10⁷, particularly preferably from 5×10⁴ to 5×10⁶. In a case where the polymer is a linear polymer, if the molecular weight is too small, physical properties such as the degree of swelling will change with time, and thus the durability may be insufficient. On the other hand, if the molecular weight is too large, processability such as moldability may be decreased. Accordingly, in a case where the polymer is a linear polymer, it is more preferably at least 1×10⁵ within the above range. On the other hand, in a case where the polymer is a crosslinked polymer, it is a high molecular weight product having a three dimensional network structure, and measurement of its molecular weight is difficult.

The fluorosulfonyl group-containing perfluoropolymer of the present invention is a polymer obtained by polymerizing at least one monomer (a) or by copolymerizing at least one monomer (a) and at least one monomer (b). Polymerization is carried out usually in the presence of a polymerization initiator. The polymerization initiator is preferably a radical generator, and is preferably an organic peroxide, an azo compound, an inorganic peroxide or the like which can generate radicals at the polymerization temperature. The amount of use of the polymerization initiator is preferably from 0.1 to 10%, more preferably from 0.5 to 5% by the mass ratio to the total amount of the monomers. Specifically, the polymerization initiator may, for example, be a bis(fluoroacyl)peroxide, a bis(chlorofluoroacyl)peroxide, a bisalkyl peroxydicarbonate, a diacyl peroxide, a peroxyester, an azo compound or a persulfate.

### <Precursor Material and its Production Process>

The precursor material of the present invention is a precursor material comprising a fluorosulfonyl group-containing perfluoropolymer obtained by polymerizing the monomer (a) (and further optionally the monomer (b)) in the presence of noble metal catalyst fine particles supported carbon particles, and the noble metal catalyst fine particles supported carbon particles. This precursor material is obtained by polymerizing the monomer (a) (and further optionally the monomer (b)) in the presence of the noble metal catalyst fine particles supported carbon particles. With respect to the quantitative ratio of the amount of the fluorosulfonyl group-containing perfluoropolymer to the amount of carbon in the noble metal catalyst fine particles supported carbon particles in the precursor material, it is preferred that from 5 to 300 parts by mass, particularly preferably from 10 to 200 parts by mass of the perfluoropolymer having fluorosulfonyl groups is contained per 100 parts by mass of carbon of the noble metal catalyst fine particles supported carbon particles.

As a method of polymerizing the monomer, a known polymerization method such as suspension polymerization, emulsion polymerization, solution polymerization or bulk polymerization to be usually employed for preparation of a fluoroolefin polymer may be employed. The monomer (a) is usually liquid at room temperature, and is preferably liquid at least under the polymerization conditions. The monomer (b) is usually liquid or gaseous at room temperature, and is preferably liquid or gaseous at least under the polymerization conditions. The mutual solubility of them is high, and usually they are uniformly mixed, and in a case where the monomer (b) is gaseous, the monomer (b) is dissolved in the monomer (a). In a case where the monomer (a) and the monomer (b) are copolymerized, it is preferred to carry out polymerization by charging a mixture of them into a polymerization vessel, or to carry out polymerization while the monomer (b) is introduced to a polymerization vessel into which the monomer (a) has been charged. As the polymerization conditions, the polymerization temperature depends on the type of the polymerization initiator used and is usually from about −20° C. to about +150° C., preferably from 25 to 100° C. As the pressure, normal pressure to pressurized condition may be employed. The polymerization time depends on the reactivity of the monomer, and is usually from about 1 hour to about 50 hours.

As a polymerization method when the monomer is polymerized in the presence of the noble metal catalyst fine particles supported carbon particles, the above-described known polymerization method such as suspension polymerization, emulsion polymerization, solution polymerization or bulk polymerization may be employed. In order to form a precursor material in which the polymer and the surface of the noble metal catalyst fine particles supported carbon particles are in close contact with each other, it is preferred to polymerize the monomer in the interior (the internal space of the secondary particles or the interior of the pores of the primary particles) of the carbon particles. In the present invention, it is considered that the monomer can infiltrate into the internal space of the secondary particles or the interior of the pores of the primary particles of the carbon particles by bringing the liquid or gaseous monomer or the monomer dissolved in a solvent into contact with the carbon particles. Accordingly, it is considered that a precursor material in which the carbon particles and the polymer are in close contact with each other can be obtained by polymerizing the monomer which has infiltrated into the internal space of the secondary particles or the interior of pores of the primary particles.

As the polymerization method, suspension polymerization or emulsion polymerization which employs an aqueous medium is particularly preferred, and among them, suspension polymerization is preferred. In the present invention, since the amount of the polymer is small relative to the volume of the noble metal catalyst fine particles supported carbon particles, bulk polymerization is not easy. Further, with respect to the solution polymerization, it is not easy to densely fill the vicinity of the surface of the carbon particles or the interior of the carbon particles with the polymer. On the other hand, in the case of the suspension polymerization and the emulsion polymerization, the monomer can sufficiently infiltrate into the interior of the carbon particles by forming suspended particles or emulsified particles containing the carbon particles and the monomer, followed by polymerization. Further, formation of the suspended particles or the emulsified particles is easy even if the amount of the monomer is small, and particles of the precursor material with a relatively small amount of the polymer can easily be produced. Further, in a case where the crosslinked polymer is to be produced, since the precursor material to be produced is in the form of relatively small particles, there is only a little difficulty even when the polymer has low processability. For example, in the case of bulk polymerization, processing such as crushing the obtained material in the form of a mass will be required, but such processing is usually not necessary for the precursor material obtained by suspension polymerization or emulsion polymerization. In the present invention, usually suspension polymerization is employed as the polymerization method from the size of the noble metal catalyst fine particles supported carbon particles.

In the above suspension polymerization, basically, water, a powder comprising the noble metal catalyst fine particles supported carbon particles, the monomer and the polymerization initiator are added in a polymerization vessel and vigorously stirred to form suspended particles containing the catalyst supported carbon particles, the monomer and the polymerization initiator, and the temperature of the system is increased while this state is maintained to carry out the polymerization. As described above, part of the monomer may be added at the time of initiation of the polymerization or during the polymerization. The powder comprising the catalyst supported carbon particles, the monomer and the polymerization initiator to be added to the polymerization vessel are preferably preliminarily mixed, and the mixture is added to an aqueous medium in the polymerization vessel. The aqueous medium may contain a small amount of a water soluble chain transfer agent as a molecular weight modifier in addition to water. The water soluble chain transfer agent is preferably a water soluble polar solvent uniformly miscible with water, such as a water soluble alcohol such as methanol or ethanol. Further, a solvent to dissolve the monomer and the polymerization initiator may be used. This solvent is usually water-insoluble, and is used to dissolve the monomer and the initiator to make them dispersed in the aqueous medium. Further, in the suspension polymerization, various additives which are used for conventional suspension polymerization may be used. For example, a small amount of a surfactant such as an emulsifier may be added to stabilize dispersion of the suspended particles. In addition, a pH buffer, a hydrophobic chain transfer agent as a molecular weight modifier or the like may be used as the case requires. In the suspension polymerization, the total amount of the catalyst supported carbon particles and the monomer is suitably from about 1 to about 30 mass % to the aqueous medium.

In order that in the after-mentioned conversion of fluorosulfonyl groups to sulfonic acid groups, the reaction of converting substantially all the fluorosulfonyl groups in the polymer to sulfonic acid groups may be carried out in a relatively short time, the precursor material is preferably in the form of particles with a small particle size. In a case where relatively large particles or agglomerated particles are obtained in the suspension polymerization or by other polymerization method, the particle size can be reduced by crushing or the like. The average particle size of the precursor material is preferably less than 10 μm, particularly preferably less than 5 μm as measured by MT3300 manufactured by Microtrac.

### <Material for Catalyst Layer and its Production Process>

The material for a catalyst layer is obtained by converting the fluorosulfonyl groups in the fluorosulfonyl group-containing perfluoropolymer contained in the precursor material to sulfonic acid groups. Conversion to sulfonic acid groups is preferably carried out by a known method of hydrolyzing the fluorosulfonyl groups with an alkali. For example, it is carried out by dispersing the precursor material in an alkaline aqueous solution, hydrolyzing fluorosulfonyl groups to obtain sulfonate groups, and then converting the cation (such as K⁺) of the sulfonate groups to hydrogen ion. The hydrolysis reaction and the conversion of the cation are carried out usually at a temperature of from 0° C. to 120° C. The alkaline aqueous solution is preferably a solution having an alkali such as an alkali metal hydroxide such as NaOH or KOH dissolved in water or a mixed solvent of water with a polar solvent. Conversion of the cation (such as K⁺) of the sulfonate groups to hydrogen ion is preferably carried out by contact with an aqueous solution of an acid such as hydrochloric acid, nitric acid or sulfuric acid. The polar solvent is preferably a polar solvent miscible with water such as an alcohol such as methanol or ethanol or dimethylsulfoxide.

The ion exchange capacity of the perfluoropolymer having sulfonic acid groups to be obtained is preferably from 0.5 to 3.5 meq/g dry polymer, particularly preferably from 1 to 3 meq/g dry polymer. If the ion exchange capacity of the sulfonic acid group-containing perfluoropolymer is less than 0.5 meq/g dry polymer, the electrical resistance will be high, and required electrical properties as a polymer electrolyte to constitute a migration channel for hydrogen ions will not be satisfied. The larger the ion exchange capacity, the better, but the upper limit of the possible ion exchange capacity of the polymer is determined by the molecular weight of the fluorosulfonyl group-containing monomer. Accordingly, the upper limit of the ion exchange capacity of the sulfonic acid group-containing perfluoropolymer is at a level of 3.5 meq/g dry polymer. As a polymer electrolyte having high electrical properties and having favorable other mechanical properties, preferred is a sulfonic acid group-containing perfluoropolymer having an ion exchange capacity of from 1 to 3 meq/g dry polymer. In the case of a linear polymer, the ion exchange capacity is particularly preferably from 1 to 2 meq/g dry polymer, and in the case of a crosslinked polymer, in order to make use of its properties, the ion exchange capacity is particularly preferably from 1.5 to 3 meq/g dry polymer.

The quantitative ratio of the sulfonic acid group-containing perfluoropolymer to the carbon of the noble metal catalyst fine particles supported carbon particles in the material for a catalyst layer to be obtained is substantially equal to the quantitative ratio of the fluorosulfonyl group-containing perfluoropolymer to the carbon of the noble metal catalyst fine particles supported carbon particles in the precursor material, since although there is a difference between the fluorosulfonyl groups and the sulfonic acid groups, the difference relative to the molecular weight of the polymer can be substantially negligible. Accordingly, as described above, the quantitative ratio of the sulfonic acid group-containing fluoropolymer to the carbon of the noble metal catalyst fine particles supported carbon particles in the material for a catalyst layer is preferably such that from 5 to 300 parts by mass, particularly preferably from 10 to 200 parts by mass of the perfluoropolymer having sulfonic acid groups is contained per 100 parts by mass of the carbon of the noble metal catalyst fine particles supported carbon particles.

### <Membrane/Electrode Assembly for Polymer Electrolyte Fuel Cell and its Production Process>

The membrane/electrode assembly for a polymer electrolyte fuel cell of the present invention is a membrane/electrode assembly comprising an anode layer containing a catalyst layer, a cathode layer containing a catalyst layer and a polymer electrolyte membrane disposed between the anode layer and the cathode layer, wherein the catalyst layer of at least one of the anode layer and the cathode layer contains the above material for a catalyst layer. Further, the membrane/electrode assembly of the present invention is produced by producing a material for a catalyst layer by the above production process, and forming a catalyst layer using the material for a catalyst layer on at least one side of a polymer electrolyte membrane (provided that when the catalyst layer using the material for a catalyst layer is formed on only one side, the other catalyst layer is formed by another material).

The membrane/electrode assembly of the present invention has a similar structure to a conventional membrane/electrode assembly, and at least one of its two catalyst layers contains the above material for a catalyst layer. One of the catalyst layers may be a catalyst layer using a conventional material. The material for a catalyst layer of the present invention may be used as the material for a catalyst layer of the anode layer, but is particularly suitable as a material for a catalyst layer of the cathode layer. Since the reaction at the cathode layer tends to depend on the catalyst amount as compared with the reaction at the anode layer, in order to improve the fuel cell performance, it is effective to increase the utilization efficiency of the catalyst in the cathode layer rather than the anode layer. Further, in the cathode layer, water is formed by the reaction, whereby the polymer in the layer is likely to swell, whereby the electrode structure tends to collapse, and the reaction gas will hardly pass through the electrode. Accordingly, particularly as the sulfonic acid group-containing perfluoropolymer in the cathode layer, use of a crosslinked polymer which swells to a lesser extent is useful.

The catalyst layer containing the material for a catalyst layer may further contain a component other than the material for a catalyst layer. For example, in a case where the sulfonic acid group-containing perfluoropolymer in the material for a catalyst layer is a crosslinked polymer having low processability, a linear polymer such as a thermoplastic perfluoropolymer may be used as a binder. Further, in a case where the amount of the sulfonic acid group-containing perfluoropolymer in the material for a catalyst layer is not sufficient as the polymer amount in the catalyst layer (e.g. in a case where the amount of the noble metal catalyst fine particles supported carbon particles is too large), another sulfonic acid group-containing polymer may be used in combination with the material for a catalyst layer. The polymer as the binder is preferably a sulfonic acid group-containing polymer, and a known sulfonic acid group-containing polymer (e.g. a sulfonic acid group-containing perfluoropolymer obtained from a copolymer of a fluorosulfonyl group-containing perfluoromonomer represented by the above formula (1), (2), (3) or the like with TFE) or a linear sulfonic acid group-containing perfluoropolymer obtained in the same manner as above from a copolymer of the monomer (a) with the non-crosslinkable monomer (b). The sulfonic acid group-containing polymer to be used in combination is also preferably such a linear sulfonic acid group-containing perfluoropolymer or a crosslinked sulfonic acid group-containing perfluoropolymer. Even in a case where such a polymer is used, the average ion exchange capacity of all the polymers is preferably within the above range, and the ratio of the sulfonic acid group-containing perfluoropolymers to the noble metal catalyst fine particles supported carbon particles in the catalyst layer is also preferably within the above range. Further, a processing aid (such as a dispersing agent) to facilitate formation of the catalyst layer may be used in a small amount in combination with the material for a catalyst layer.

The catalyst layer is preferably formed by using a slurry having the above material for a catalyst layer and the like dispersed in a liquid dispersion medium. Further, the material for a catalyst layer and the like may be directly formed into a sheet e.g. by pressing to form a catalyst layer. In a case where the above slurry (hereinafter referred to as a coating fluid) is used, the coating fluid may be directly applied on a polymer electrolyte membrane (hereinafter simply referred to as an electrolyte membrane), and the dispersion medium is removed to form a catalyst layer. Further, it is also possible to apply the coating fluid on a releasable support film, remove the dispersion medium, and then laminate the formed catalyst layer on an electrolyte membrane, and then remove the releasable support film to form a catalyst layer on the electrolyte membrane. Further, it is also possible to apply the coating fluid on a material for a diffusion layer such as carbon paper as described hereinafter to form a catalyst layer and a gas diffusion layer on an electrolyte membrane in a similar manner. Further, a catalyst layer can be formed in the same manner by using a slurry not containing the material for a catalyst layer and containing the noble metal catalyst fine particles supported carbon particles and the sulfonic acid group-containing perfluoropolymer. The thickness of the catalyst layer can be adjusted by adjusting the solid content concentration of the coating fluid or by adjusting the number of repetition of coating. By such a method, a catalyst layer can be formed on both sides of the electrolyte membrane.

As the liquid dispersion medium used for the coating fluid (slurry) containing the material for a catalyst layer, a liquid dispersion medium which has been used heretofore for formation of a catalyst layer using a sulfonic acid group-containing perfluoropolymer may be used. The solid content concentration of the coating fluid is preferably from 1 to 30 mass %, particularly preferably from 5 to 20 mass %.

The electrode layer on each side of the electrolyte membrane usually has a gas diffusion layer outside the catalyst layer (the side not in contact with the electrolyte membrane). Further, it may further have other layer (such as water repellent layer) between the catalyst layer and the gas diffusion layer or outside the gas diffusion layer. The gas diffusion layer has a function to uniformly diffuse gas to the catalyst layer and a function as a current collector.

As the electrolyte membrane, known one (e.g. an electrolyte membrane using a sulfonic acid group-containing perfluoropolymer obtained from a copolymer of a fluorosulfonyl group-containing perfluoromonomer represented by the above formula (1), (2), (3) or the like with TFE) may be used. Further, an electrolyte membrane obtained by using a commercially available sulfonic acid group-containing perfluoropolymer for an electrolyte membrane or a commercially available electrolyte membrane may be used. The electrolyte membrane in the present invention is not limited to the above sulfonic acid group-containing perfluoropolymer, and it may be constituted by another polymer having sulfonic acid groups. Further, the electrolyte membrane of the present invention is not limited to one comprising a sulfonic acid group-containing polymer alone, and it may be a reinforced membrane reinforced by a reinforcing material such as fibrils or a porous body of polytetrafluoroethylene. Further, the electrolyte membrane of the present invention may be a denatured electrolyte membrane. For example, it has been known that by denaturing an electrolyte membrane comprising a sulfonic acid group-containing perfluoropolymer by metal ions of e.g. cerium, its durability is improved. By using such a denatured electrolyte membrane for the membrane/electrode assembly of the present invention, a membrane/electrode assembly having more excellent durability can be obtained.

The gas diffusion layer comprises a porous electric conductor, and is particularly preferably a porous body comprising a carbonaceous material. Specifically, a carbonaceous porous body such as carbon paper or carbon cloth which has been usually used as a material for a gas diffusion layer is preferred. The gas diffusion layer is formed by laminating a gas diffusion layer material on the surface of the catalyst layer formed as described above. For example, the gas diffusion layer may be formed by a method of forming a catalyst layer on the surface of an electrolyte membrane as described above, and then laminating a gas diffusion layer material on the surface of the catalyst layer. Otherwise, the gas diffusion layer may be formed by a method of forming a laminate having a catalyst layer and a gas diffusion layer and then laminating an electrolyte membrane on the surface of the catalyst layer of the laminate. Another layer such as a water repellent layer may also be formed in the same manner. For example, in a case of forming a water repellent layer comprising a fluororesin and the like on the surface of the gas diffusion layer, the layer can be formed in the same manner as above. Further, a gas diffusion layer having water repellency can be formed by using a gas diffusion layer material the surface of which is preliminarily coated with a water repellent material, or by using a gas diffusion layer material preliminarily impregnated with a water repellent material.

The membrane/electrode assembly of the present invention is sandwiched between a separator having grooves formed to constitute flow paths for a fuel gas such as hydrogen and a separator having grooves formed to constitute flow paths for an oxidant gas such as air, which is incorporated in a cell to obtain a fuel cell. For example, in the case of a polymer electrolyte fuel cell, a hydrogen gas is supplied to the anode side of the membrane/electrode assembly, and oxygen or air is supplied to the cathode side. The membrane/electrode assembly of the present invention may be used for not only a hydrogen/oxygen type fuel cell but also a direct methanol fuel cell (DMFC). Methanol or a methanol aqueous solution to be used as a fuel for DMFC may be a liquid feed or a gas feed.

### EXAMPLES

Now, the present invention will be described in further detail with reference to Examples, but it should be understood that the present invention is by no means restricted to such specific Examples.

In Examples, the following abbreviations are employed.

AK225cb: CClF₂CF₂CHClF

AK141b: CH₃CCl₂F

IPP: Diisopropyl peroxydicarbonate

S1a: Compound represented by the following formula (1a)

S3a: Compound represented by the following formula (3a)

S4a: Compound represented by the following formula (4a)

D8a: Compound represented by the following formula (8a)

MMD: Compound represented by the following formula (10)

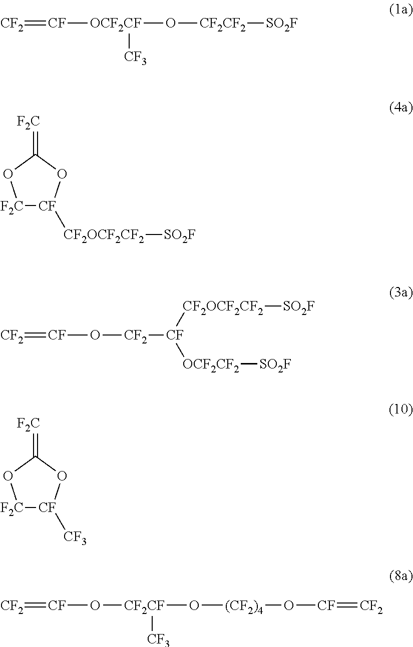

### Example 1

### Preparation of Precursor Material C1

Into a 1,000 ml four-necked round bottom flask equipped with a thermometer, a Dimroth condenser and a stirrer, 138 g of a slurry having 12.5-g of platinum supported carbon (TEC10E50E, manufactured by TANAKA KIKINZOKU) having an amount of platinum supported of 50 mass %, which is a powder comprising platinum catalyst fine particles supported carbon particles, dispersed in water by ultrasonic waves, and 393 g of water were added. A mixed liquid of 16.08 g of S4a, 4.02 g of D8a and 609 mg of IPP was added with slow stirring, and 106.5 g of water was further added. After sufficiently stirring for 10 minutes, the mixture was cooled to an internal temperature of 5° C. or below in an ice bath. The pressure was gradually decreased to 13.3 kPa by using a vacuum pump, and nitrogen was introduced to recover the pressure to atmospheric pressure. This operation of decreasing the pressure and introducing nitrogen was repeatedly carried out three times in total. The internal temperature was raised to 40° C. in a water bath. After stirring at 40° C. for 7 hours, the mixture was subjected to filtration, and the obtained solid was washed with dichloromethane. The solid was dried in a vacuum oven at 60° C. until constant weight was obtained to obtain 18.08 g of solid content C1. The increase was 89 parts by mass relative to 100 parts by mass of the carbon of the platinum catalyst fine particles supported carbon particles.

### Example 2

### Preparation of Precursor Material C2

Into a 1,000 ml four-necked round bottom flask equipped with a thermometer, a Dimroth condenser, a dropping funnel (no side tube) and a stirrer, 15.00 g of the same platinum supported carbon as in Example 1 (TEC10E50E, manufactured by TANAKA KIKINZOKU) having an amount of platinum supported of 50 wt % was added. The flask was cooled with dry ice/ethanol. The system was evacuated of air by a vacuum pump. A mixed liquid of 11.45 g of S4a, 11.05 g of MMD, 4.50 g of AK225cb and 450 mg of IPP was added to the dropping funnel, and then a small amount of water was added. The vacuum line was closed, and the monomer mixed liquid was added from the dropping funnel to the flask with slow stirring. After the cooling bath was removed, 750 g of water into which nitrogen was preliminarily bubbled was added from the dropping funnel. Nitrogen gas was introduced to the flask, followed by nitrogen sealing. After sufficient stirring for 10 minute, the internal temperature was raised to 40° C. in a water bath. After stirring at 40° C. for 7 hours, the mixture was subjected to filtration, and the obtained solid was washed with dichloromethane. The solid was dried in a vacuum oven at 60° C. until constant weight is obtained to obtain 17.11 g of solid content C2. The increase was 28 parts by mass per 100 parts by mass of the carbon of the platinum catalyst fine particles supported carbon particles.

### Example 3

### Preparation of Material E1 for Catalyst Layer

The above obtained precursor material C1 was immersed in an aqueous solution containing 30 mass % of methanol and 15 mass % of potassium hydroxide at 80° C. for 16 hours to hydrolyze and convert —SO₂F groups in the polymer to —SO₃K groups. Then, the polymer was immersed in a 3 mol/L hydrochloric acid aqueous solution at 25° C. for 2 hours. The hydrochloric acid aqueous solution was changed, and the same treatment was repeatedly carried out further four times. The precursor material was sufficiently washed with deionized water to obtain material E1 for a catalyst layer having —SO₃K groups in the polymer converted to sulfonic acid groups. Elemental analysis of material E1 for a catalyst layer was carried out, whereupon the ion exchange capacity of the polymer was 2.2 meq/g dry polymer.

### Example 4

### Preparation of Material E2 for Catalyst Layer

Material E2 for a catalyst layer was obtained from precursor material C2 in the same manner as in Example 3. Elemental analysis of material E2 for a catalyst layer was carried out, whereupon the ion exchange capacity of the polymer was 1.8 meq/g dry polymer.

### Example 5

### Preparation of Electrolyte Liquid Composition S2

### Example 5-1

### Synthesis of Polymer P2

By a method described in WO2007-013532, S3a was synthesized and further copolymerized with tetrafluoroethylene to obtain polymer P2. The TQ value of polymer P2 was 248° C.

The TQ value is an index for the melt fluidity, and is defined as a temperature (° C.) at which the melt volume rate is 100 mm³/sec. The melt volume rate is the amount of the polymer extruded when the polymer is subjected to melt extrusion under a pressure of 2.94 MPa from a nozzle having a length of 1 mm and an inner diameter of 1 mm, represented by the unit of mm³/sec.

The above obtained polymer P2 was immersed in an aqueous solution containing 30 mass % of dimethylsulfoxide and 15 mass % of potassium hydroxide at 80° C. for 16 hours to hydrolyze and convert —SO₂F groups in the polymer to —SO₃K groups. Then, the polymer was immersed in a 3 mol/L hydrochloric acid aqueous solution at 50° C. for 2 hours. The hydrochloric acid aqueous solution was changed, and the same treatment was repeated further four times. The polymer was sufficiently washed with deionized water to obtain polymer Q2 having —SO₃K groups in the polymer converted to sulfonic acid groups. The ion exchange capacity of polymer Q2 was 1.64 meq/g dry polymer.

### Example 5-2

### Preparation of Electrolyte Liquid Composition S2

To polymer Q2, a mixed solvent of ethanol, water and 1-butanol (ethanol/water/1-butanol=35/50/15 mass ratio) was added to adjust the solid content concentration to 15 mass %, followed by stirring using an autoclave at 125° C. for 8 hours. Water was further added to adjust the solid content concentration to 9.5 mass % to obtain liquid composition S2 having polymer Q2 dispersed in a dispersion medium. The composition of the dispersion medium was ethanol/water/1-butanol=21/70/9 (mass ratio).

### Example 6

### Preparation of Polymer Electrolyte Membrane

Liquid composition S2 was applied on a sheet comprising a copolymer of ethylene and tetrafluoroethylene (tradename: Aflex 100N, manufactured by Asahi Glass Company, Limited, thickness: 100 μm) (hereinafter referred to as an ETFE sheet) by means of a die coater and dried at 80° C. for 30 minutes and further subjected to annealing at 190° C. for 30 minutes to form a polymer electrolyte membrane having a thickness of 25 μm.

### Example 7

### Preparation and Evaluation of Membrane/Electrode Assembly MEA1

8 g of the above obtained material E1 for a catalyst layer was added to 31 g of water, and 36 g of ethanol was further added, followed by application of ultrasonic waves for 10 minutes to obtain a dispersion of the catalyst. To the dispersion of the catalyst, 14 g of liquid composition S2 was added to adjust the solid content concentration to 10.5 mass % to obtain a fluid for formation of a catalyst layer. This fluid was applied on a separately prepared ETFE sheet and dried to form a catalyst layer having a platinum amount of 0.2 mg/cm².

The ETFE sheet was separated from the above obtained polymer electrolyte membrane, the polymer electrolyte membrane was sandwiched between two sheets of the catalyst layers and subjected to hot pressing at a pressing temperature of 150° C. for a pressing time of 5 minutes under a pressure of 3 MPa to bond the catalyst layers on both sides of the polymer electrolyte membrane, and the ETFE film was separated from each catalyst layer to obtain a membrane/catalyst layer assembly having an electrode area of 25 cm². The membrane/catalyst layer assembly was subjected to heat treatment at 160° C. for 30 minutes in nitrogen atmosphere to stabilize the proton conductive polymer in the catalyst layers.

A carbon layer comprising carbon and polytetrafluoroethylene was formed on a gas diffusion layer comprising carbon paper. The membrane/catalyst layer assembly was sandwiched between such gas diffusion layers so that the carbon layer and the catalyst layer were in contact with each other to obtain membrane/electrode assembly MEA1.

Membrane/electrode assembly MEA1 was assembled into a cell for power generation, and while the temperature of the membrane/electrode assembly was maintained at 80° C., hydrogen was supplied to the anode side at 70 ml/min and oxygen was supplied to the cathode side at 166 ml/min under a pressure of 150 kPa (absolute pressure). Both hydrogen and air were humidified under a relative humidity of 100%, and the cell voltage and the resistance at each current density were recorded. Further, IR Free voltage corrected with the resistance was calculated, and the current density when the value of the voltage became 0.9 V was determined. The mass activity of the electrode was evaluated by the value obtained by dividing the above current density by the mass of platinum per unit area used for the cathode (see the following formula). The mass activity of the electrode is an index for the activity of the electrode per unit mass of platinum, and an electrode having a higher mass activity exhibits a higher power generation performance at the same platinum amount in the electrode. The results are shown in Table 1.

Mass activity of electrode=(Current density when IR Free voltage becomes 0.9 V)/(Mass of platinum per unit area of cathode)

### Example 8

### Preparation and Evaluation of Membrane/Electrode Assembly MEA2

8 g of the above obtained material E2 for a catalyst layer was added to 39 g of water, and 38 g of ethanol was further added, followed by application of ultrasonic waves for 10 minutes to obtain a dispersion of the catalyst. To the dispersion of the catalyst, 8 g of a liquid composition containing an electrolyte obtained by subjecting a copolymer (TQ: 220° C.) of S1a with tetrafluoroethylene to alkali hydrolysis and conversion to an acid form (ion exchange capacity of electrolyte polymer: 1.1 meq/g dry polymer, solvent composition: ethanol/water 60/40 mass %, solid content concentration: 28 wt %, hereinafter referred to as liquid composition A) was added and the solid content concentration was adjusted to 11 mass % to obtain a fluid for formation of a catalyst layer. This fluid was applied on a separately prepared ETFE sheet and dried to form a catalyst layer having a platinum amount of 0.2 mg/cm². Then, membrane/electrode assembly MEA2 is prepared in the same manner as in Example 7, and the mass activity of the electrode is evaluated in the same manner. The results are shown in Table 1.

### Example 9

### Comparative Example

### Preparation of Membrane/Electrode Assembly MEA3

49 g of water was added to 8 g of platinum supported carbon having an amount of platinum supported of 50 wt % (TEC10E50E, manufactured by TANAKA KIKINZOKU), and 47 g of ethanol was further added, followed by application of ultrasonic waves for 10 minutes to obtain a dispersion of the catalyst. To the dispersion of the catalyst, 13 g of liquid composition A was added and the solid content concentration was adjusted to 10 mass % to obtain a fluid for formation of a catalyst layer. This fluid was applied on a separately prepared ETFE sheet and dried to form a catalyst layer having a platinum amount of 0.2 mg/cm². Then, membrane/electrode assembly MEA3 was prepared in the same manner as in Example 7, and the mass activity of the electrode was evaluated in the same manner. The results are shown in Table 1.

TABLE 1

| | Membrane/ | Mass activity |
|---|---|---|
| | electrode | of electrode |
| Ex. | assembly | (A/mg-Pt) |
| 7 | MEA1 | 0.09 |
| 8 | MEA2 | 0.06 |
| 9 | MEA3 | 0.04 |

### INDUSTRIAL APPLICABILITY

The material for a catalyst layer of the present invention is a material comprising a noble metal catalyst and a polymer electrolyte, and is used for a catalyst layer of a polymer electrolyte fuel cell. The precursor material of the present invention is a precursor for production of such a material for a catalyst layer. The membrane/electrode assembly of the present invention is used as a membrane/electrode assembly for a polymer electrolyte fuel cell.

The entire disclosure of Japanese Patent Application No. 2008-101477 filed on Apr. 9, 2008 including specification, claims and summary is incorporated herein by reference in its entirety.

What is claimed is:

1. A precursor material of a material for a catalyst layer for a polymer electrolyte fuel cell, comprising carbon particles having noble metal catalyst fine particles supported and a perfluoropolymer having fluorosulfonyl groups, wherein the perfluoropolymer having fluorosulfonyl groups is obtained by polymerizing a perfluoromonomer having a fluorosulfonyl group in the presence of the noble metal catalyst fine particles supported carbon particles.

2. The precursor material according to claim 1, which contains from 5 to 300 parts by mass of the perfluoropolymer having fluorosulfonyl groups per 100 parts by mass of carbon of the noble metal catalyst fine particles supported carbon particles.

3. The precursor material according to claim 1, wherein the perfluoropolymer having fluorosulfonyl groups is a crosslinked perfluoropolymer.

4. A material for a catalyst layer for a polymer electrolyte fuel cell, comprising carbon particles having noble metal catalyst fine particles supported and a perfluoropolymer having sulfonic acid groups, wherein the perfluoropolymer having sulfonic acid groups is obtained by polymerizing a perfluoromonomer having a fluorosulfonyl group in the presence of the noble metal catalyst fine particles supported carbon particles, and then converting the fluorosulfonyl groups of the polymer to sulfonic acid groups.

5. The material for a catalyst layer according to claim 4, which contains from 5 to 300 parts by mass of the perfluoropolymer having sulfonic acid groups per 100 parts by mass of carbon of the noble metal catalyst fine particles supported carbon particles.

6. The material for a catalyst layer according to claim 4, wherein the perfluoropolymer having sulfonic acid groups is a crosslinked perfluoropolymer.

7. A process for producing a precursor material of a material for a catalyst layer for a polymer electrolyte fuel cell, comprising carbon particles having noble metal catalyst fine particles supported and a perfluoropolymer having fluorosulfonyl groups, which comprises polymerizing a perfluoromonomer having a fluorosulfonyl group in the presence of the noble metal catalyst fine particles supported carbon particles to form the perfluoropolymer having fluorosulfonyl groups.

8. The process for producing a precursor material according to claim 7, wherein a perfluoromonomer having no fluorosulfonyl group is copolymerized together with the perfluoromonomer having a fluorosulfonyl group.

9. The process for producing a precursor material according to claim 8, wherein the perfluoromonomer having no fluorosulfonyl group is a perfluoromonomer having at least two addition polymerizable groups.

10. The process for producing a precursor material according to claim 7, wherein the perfluoromonomer having a fluorosulfonyl group is a perfluoromonomer having a 2-methylene-1,3-dioxolane structure.

11. The process for producing a precursor material according to claim 7, wherein polymerization is carried out in an aqueous medium.

12. The process for producing a precursor material according to claim 7, wherein the precursor material contains from 5 to 300 parts by mass of the perfluoropolymer having fluorosulfonyl groups per 100 parts by mass of carbon of the noble metal catalyst fine particles supported carbon particles.

13. A process for producing a material for a catalyst layer for a polymer electrolyte fuel cell, comprising carbon particles having noble metal catalyst fine particles supported and a perfluoropolymer having sulfonic acid groups, which comprises producing the precursor material by the production process as defined in claim 7, and then converting fluorosulfonyl groups of the polymer in the precursor material to sulfonic acid groups to obtain the perfluoropolymer having sulfonic acid groups.

14. The process for producing a material for a catalyst layer according to claim 13, wherein the perfluoropolymer having sulfonic acid groups has an ion exchange capacity of from 0.5 to 3.5 meq/g dry polymer.

15. A membrane/electrode assembly for a polymer electrolyte fuel cell comprising an anode layer containing a catalyst layer, a cathode layer containing a catalyst layer, and a polymer electrolyte membrane disposed between the anode layer and the cathode layer, wherein the catalyst layer of at least one of the anode layer and the cathode layer contains the material for a catalyst layer as defined in claim 4.

16. A process for producing a membrane/electrode assembly for a polymer electrolyte fuel cell comprising an anode layer containing a catalyst layer, a cathode layer containing a catalyst layer, and a polymer electrolyte membrane disposed between the anode layer and the cathode layer, which comprises producing a material for a catalyst layer by the production process as defined in claim 13, and then forming a catalyst layer using the material for a catalyst layer on at least one side of the polymer electrolyte membrane (provided that when the catalyst layer using the material for a catalyst layer is formed on only one side, the other catalyst layer is formed by another material).
